(19) United States
(12) Patent Application Publication
(10) Pub. No.: US 2006/0077325 A1
(43) Pub. Date: Apr. 13, 2006

(54) Cholesteric liquid crystal light control film

(75) Inventors: Tung-Lung Li, Pingzhen City (TW); Chen-Yung Chang, Pingzhen City (TW); Long-Hai Wu, Pingzhen City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Optimax Technology Corporation, Pingzhen City (TW)

(21) Appl. No.: 11/023,883

(22) Filed: Dec. 28, 2004

(30) Foreign Application Priority Data
Oct. 13, 2004 (TW) 93131056

(51) Int. Cl. G02F 1/1335

(52) U.S. Cl. 349/115

(57) ABSTRACT

An optical film which retains the advantage of improving the brightness of LCD and resolves the color shift problem caused by cholesteric liquid crystal is provided. The optical film includes a reflective film and a brightness enhancement film. The reflective film, which is used for reflecting a first reflective light ranged in an infrared spectrum, includes a first cholesteric liquid crystal and a first transparent substrate. The brightness enhancement film includes a second transparent substrate, a second cholesteric liquid crystal and a phase retarder. The second cholesteric liquid crystal is used for reflecting a second reflective light which is incapable of passing through the brightness enhancement film. The phase retarder is used for transforming a circular polarized light passing through the second cholesteric liquid crystal into a linear polarized light.

### FIELD OF THE INVENTION

The present invention refers to a light control film, and more particular to a light control film made of a cholesteric liquid crystal for a liquid crystal display system.

### BACKGROUND OF THE INVENTION

Recently, as the demands for the liquid crystal display (LCD) are increasing rapidly, the development of the LCD technology is becoming more and more practiced. However, some display properties, such as, the brightness, the color saturation, the response time and the viewing angles of LCD are still not as good as those of the cathode ray tube (CRT) display. Therefore, it is still necessary to pay a lot of effort to improve those performances of the LCD.

Generally, the LCD is constructed by a light source and a light valve which is composed of several optical films for directing and filtering the light transmitted therebetween. When a light is transmitted from the light source to the user's eyes, only less than 10% of the light source energy passes through the light valve because of the functions of those optical films. Therefore, the performance of the LCD brightness is not as good as the CRT display because of the architecture of the LCD. Among the optical films, the two pieces of polarizing films are the least efficient films for transmitting the light passing through. This is because the polarizing films used in LCD architecture are typically absorptive polarizing ones. The absorptive polarizing film only allows a light with a specific polarity to pass therethrough. Therefore, most of the light energy is absorbed by the polarizing films of the LCD. In order to improve the brightness of the LCD, a brightness enhancement film (BEF) is further configured into the LCD architecture. The brightness enhancement film is capable of reflecting a light which is incapable of passing through the absorptive polarizing film. Therefore, the light which is incapable of passing through the absorptive polarizing film is reflected back to the light source so that the light energy is recycled.

Please refer to FIG. 1, which is a diagram illustrating the functions of a brightness enhancement film. The brightness enhancement film consists of a cholesteric liquid crystal (CLC) film and a phase retarder. When an unpolarized light 11′ is transmitted from the backlight module 1′ to the cholesteric liquid crystal film 22′, the unpolarized light 11′ is separated into a right circular polarized light 13′ passing through the cholesteric liquid crystal film 22′ and a left circular polarized light 12′ reflected back to the backlight module 1′. The left circular polarized light 12′ is then re-reflected by the backlight module 1′ and transformed into a right circular polarized light 13′ which is capable of passing through the cholesteric liquid crystal film 22′. As a result, most of the unpolarized light 11′ can be transmitted through the cholesteric liquid crystal film 22′ so as to enhance the brightness of the LCD. Furthermore, the right circular polarized light 13′ passing through the cholesteric liquid crystal film 22′ is transformed into a linear polarized light 14′ by a phase retader 24′. The linear polarized light 14′ has a specific linear polarity and is capable of passing through the linear (absorptive) polarizing film 3′. Therefore, most unpolarized light 11′ emitted form the backlight module 1′ is capable of passing through the linear polarizing film 3′, and the brightness performance of LCD can be increased.

Although it is well known that the brightness performance of LCD can be efficiently improved by applying a cholesteric liquid crystal-based brightness enhancement film (CBEF) to the LCD architecture. However, a problem resulted from cholesteric liquid crystal film is that the image color of the LCD is shifted when the light emitted from the backlight is oblique (i.e. watching the LCD panel with a large viewing angle). This is because that the wavelength of the light reflected by the cholesteric liquid crystal varies with the pitch length of the cholesteric liquid crystal, the average refractive index of the cholesteric liquid crystal and the incident angle of the light. Since the wavelength of the reflective light is changed with the incident angle, the wavelength of the light passing through the cholesteric liquid crystal film is also changed with the viewing angle. As a result, a color shift phenomenon arises with the larger viewing angle.

From the above description, how to retain the advantage of the CBEF for the improvement of brightness and to resolve the color shift problem caused by cholesteric liquid crystal have become a major problem waited to be solved. For this purpose, a novel light control film is provided in the present invention for compensating the color shift phenomenon in a large viewing angle.

### SUMMARY OF THE INVENTION

In accordance with a first aspect of the invention, a light control film is provided. The light control film includes a reflective film for reflecting a first reflective light ranged in an infrared spectrum, a brightness enhancement film disposed on the reflective film for reflecting a second reflective light which is incapable of transmitting through the brightness enhancement film, and a polarizing film disposed on the brightness enhancement film for transmitting a light having a specific linear polarity.

Preferably, the reflective film includes a first cholesteric liquid crystal layer.

Preferably, the brightness enhancement film includes a second cholesteric liquid crystal layer and a phase retarder.

Preferably, a pitch length of the first cholesteric liquid crystal layer is different from that of the second cholesteric liquid crystal layer.

Preferably, both wavelengths of the first and the second reflective light, which are reflected respectively by the first and the second cholesteric liquid crystal layers, satisfy the following formula: λ(θ)=nP₀ cos(sin⁻¹ sin θ/n) wherein λ denotes a wavelength of a reflective light, P₀ denotes a pitch length of a cholesteric liquid crystal, n denotes an average refractive index of a cholesteric liquid crystal and θ denotes an incident angle of light.

Preferably, the phase retarder is a quarter wavelength retarder.

Preferably, the polarizing film is an absorptive polarizing film.

Preferably, the polarizing film is a linear polarizing film.

In accordance with a second aspect of the present invention, another light control film is provided. The light control film includes a transparent substrate and a reflective film, including a cholesteric liquid crystal layer, disposed on the transparent substrate for reflecting a reflective light ranged in an infrared spectrum.

Preferably, the wavelength of the reflective light satisfies the following formula: λ(θ)=nP₀ cos(sin⁻¹ sin θ/n) , wherein λ denotes the wavelength of the reflective light, P₀ denotes a pitch length of a cholesteric liquid crystal, n denotes an average refractive index of a cholesteric liquid crystal and 0 denotes an incident angle of light.

Preferably, the wavelength of the reflective light is more than 700 nm.

In accordance with a third aspect of the present invention, an optical film is provided. The optical film includes a reflective film having a first cholesteric liquid crystal layer for reflecting a first reflective light ranged in an infrared spectrum, a reflective polarizing film having a second cholesteric liquid crystal layer and disposed on the reflective film for reflecting a second reflective light which is incapable of transmitting through the reflective polarizing film, and a phase retarder disposed on the reflective polarizing film.

Preferably, both the wavelengths of the first and the second reflective light satisfy the following formula: λ(θ)=nP₀ cos(sin⁻¹ sin θ/n) wherein λ denotes a wavelength of a reflective light, P₀ denotes a pitch length of a cholesteric liquid crystal, n denotes an average refractive index of a cholesteric liquid crystal and θ denotes an incident angle of light.

Preferably, the pitch length of the first cholesteric liquid crystal layer is different from that of the second cholesteric liquid crystal layer.

Preferably, the phase retarder is a quarter wavelength retarder.

In accordance with a fourth aspect of the present invention, a liquid crystal display is provided. The liquid crystal display includes a backlight module providing a light source for the liquid crystal display, a reflective film for reflecting a first reflective light ranged in an infrared spectrum, a reflective polarizing film disposed on the reflective film for reflecting a second reflective light which is incapable of transmitting through the reflective polarizing film, a phase retarder disposed on the reflective polarizing film, a first and a second polarizing films having polarities perpendicular to each other and disposed on the phase retarder, and a liquid crystal layer sandwiched between the first and the second polarizing films for directing a light transmitted therebetween.

Preferably, the reflective film includes a first cholesteric liquid crystal layer.

Preferably,the reflective polarizing film includes a second cholesteric liquid crystal layer.

Preferably, a pitch length of the first cholesteric liquid crystal layer is different from that of the second cholesteric liquid crystal layer.

Preferably, both wavelengths of the first and the second reflective light which are reflected respectively by the first and second cholesteric liquid crystal layers satisfy the following formula: λ(θ)=nP₀ cos(sin⁻¹ sin θ/n) , wherein λ denotes a wavelength of a reflective light, P₀ denotes a pitch length of a cholesteric liquid crystal, n denotes an average refractive index of a cholesteric liquid crystal and θ denotes an incident angle of light.

Preferably, the first and the second polarizing films are absorptive polarizing films.

Preferably, the phase retarder is a quarter wavelength retarder.

The foregoing and other features and advantages of the present invention will be more clearly understood through the following descriptions with reference to the drawings, wherein:

### BRIEF DESCRIPTION OF THE DRAWINGS

FIG. 1 is a diagram illustrating the functions of a cholesteric liquid crystal-based brightness enhancement film according to the prior art;

FIG. 2 is a diagram illustrating the structure of a light control film according to a preferred embodiment of the present invention;

FIG. 3(a) is a diagram illustrating the structure of a light control film according to another preferred embodiment of the present invention;

FIG. 3(b) and (c) are diagrams illustrating the applications of the light control film shown in FIG. 3(a); and

FIG. 4 is a diagram illustrating the structure of a LCD according to a preferred embodiment of the present invention.

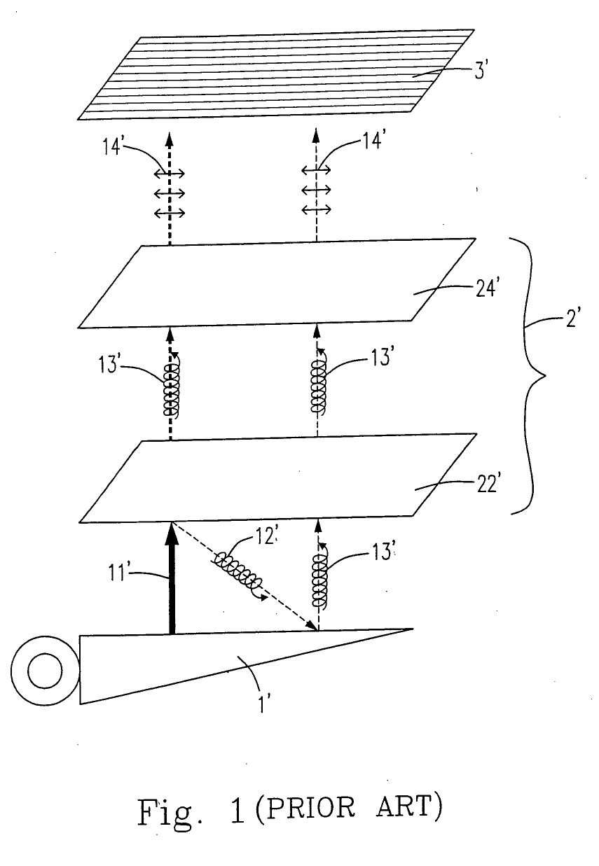

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

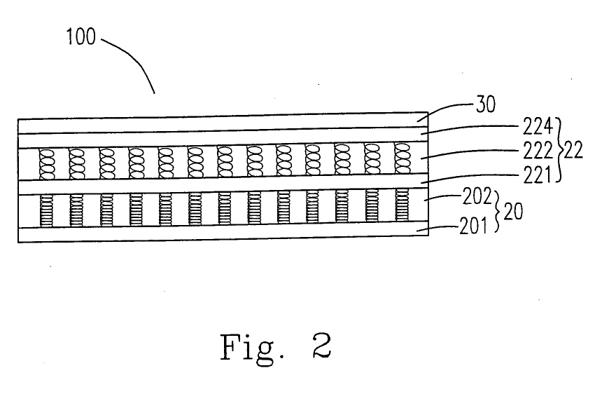

Please refer to FIG. 2, which illustrates the structure of a light control film according to a preferred embodiment of the present invention. The light control film 100 includes a reflective film 20, a brightness enhancement film 22, and a polarizing film 30. The reflective film 20, which is used for reflecting a first reflective light ranged in an infrared spectrum, further includes a first cholesteric liquid crystal 202 and a first transparent substrate 201. The brightness enhancement film 22 further includes a second transparent substrate 221, a second cholesteric liquid crystal 222 and a phase retarder 224. The second cholesteric liquid crystal 222 is used for reflecting a second reflective light which is incapable of passing through the brightness enhancement film 22. The phase retarder 224 is used for transforming a circular polarized light passing through the second cholesteric liquid crystal 222 into a linear polarized light, so that the linear polarized light is capable of being transmitted through the polarizing film 30.

In a preferred embodiment, the phase retarder 224 is a quarter wavelength plate, and the polarizing film 30 is an absorptive linear polarizing film. Both the first and the second cholesteric liquid crystal 202 and 222 have a similar helix structure. The circular direction of the first cholesteric liquid crystal 202 is the same as that of the second cholesteric liquid crystal 222, but the pitch length of the first cholesteric liquid crystal 202 is different from that of the second cholesteric liquid crystal 222. Furthermore, both wavelengths of the first and second reflective light, which are reflected respectively by the first and the second cholesteric liquid crystal 202 and 222, satisfy the formula of λ(θ)=nP₀ cos(sin⁻¹ sin θ/n) , wherein λ denotes a wavelength of a reflective light, P₀ denotes a pitch length of a cholesteric liquid crystal, n denotes an average refractive index of a cholesteric liquid crystal, and 0 denotes an incident angle of light. In this embodiment, the wavelength of the first reflective light is ranged in the infrared spectrum or more than 700nm, and the wavelength of the second reflective light is ranged in the visible light spectrum or within 400 to 700 nm. As a result, when a light from a backlight module (not shown in this diagram) propagates into the light control film 1 00 with a normal incidence, part of the incident light which is ranged in the infrared spectrum is reflected by the first cholesteric liquid crystal 202, and part of the incident light which is ranged in the visible light spectrum is reflected by the second cholesteric liquid crystal 222. However, when a light from a backlight module propagates through the light control film 100 with an oblique incidence, both wavelengths of the first and the second reflective light are shifted into shorter ones. As a result, part of the visible light with red light spectrum (near 700 nm) is capable of passing through the second cholesteric liquid crystal 222, which results in the color shift phenomenon. However, with the compensation of the first cholesteric liquid crystal 202, the light with red light spectrum would be reflected thereby since the wavelength of the infrared (more than 700 nm) is shifted into the visible light spectrum. With the combination of the first and the second cholesteric liquid crystal 202 and 222, the wavelengths respectively of the first and the second reflective lights are remained within the range of the visible light spectrum. As a result, the color shift phenomenon caused by the wavelength shift of the reflective light is eliminated with the compensation of the first cholesteric liquid crystal 202.

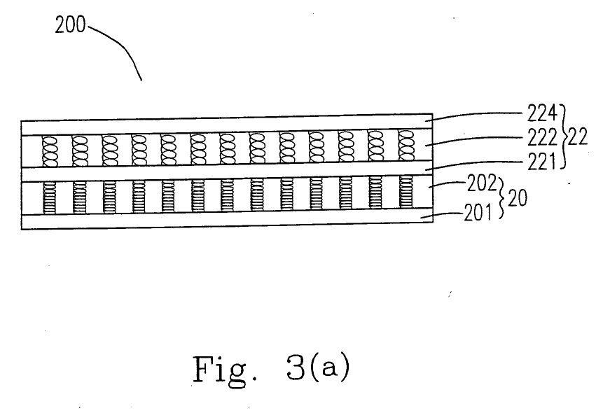

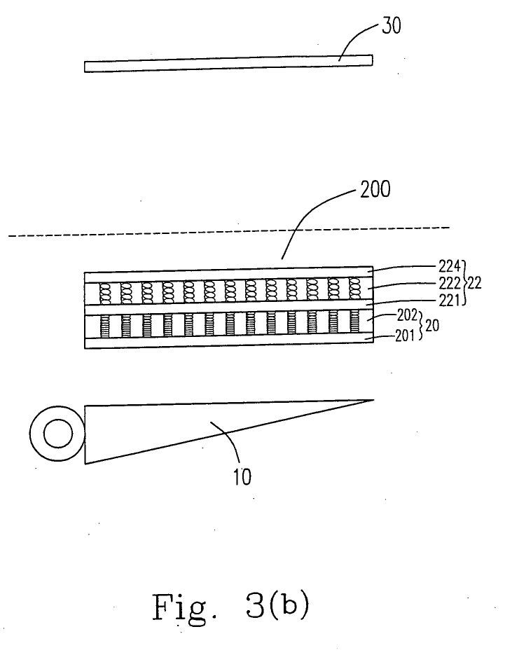

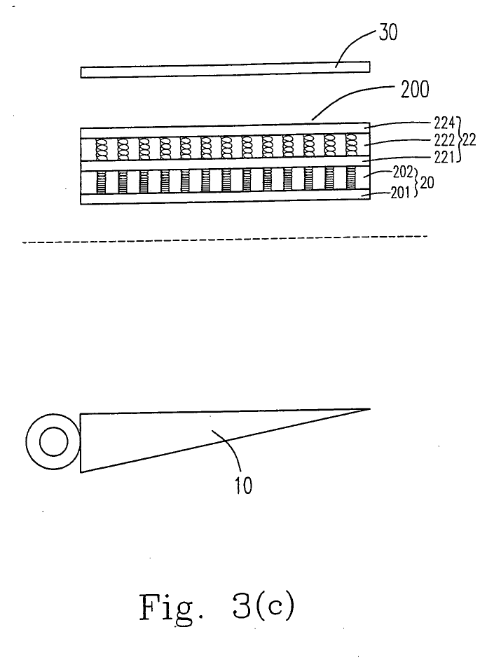

In a further embodiment of the present invention, an optical film is provided. Please refer to FIG. 3(a), which illustrates the structure of the optical film. The optical film 200 also includes a reflective film 20 and a brightness enhancement film 22. The reflective film 20, which is used for reflecting a first reflective light ranged in an infrared spectrum, includes a first cholesteric liquid crystal 202 and a first transparent substrate 201. The brightness enhancement film 22 includes a second transparent substrate 221, a second cholesteric liquid crystal 222 and a phase retarder 224. The second cholesteric liquid crystal 222 is used for reflecting a second reflective light which is incapable of passing through the brightness enhancement film 22. The phase retarder 224 is used for transforming a circular polarized light passing through the second cholesteric liquid crystal 222 into a linear polarized light.

The optical film 200 is a cholesteric liquid crystal-based compensation film. Similar to the light control film of the first embodiment, both the first and the second cholesteric liquid crystal 202 and 222 have a similar helix structure. The circular direction of the first cholesteric liquid crystal 202 is the same as that of the second cholesteric liquid crystal 222, but the pitch length of the first cholesteric liquid crystal 202 is different from that of the second cholesteric liquid crystal 222. Furthermore, both wavelengths of the first and second reflective light satisfy the following formula of λ(θ)=nP₀ cos(sin⁻¹ sin θ/n), wherein λ denotes a wavelength of a reflective light, P₀ denotes a pitch length of a cholesteric liquid crystal, n denotes an average refractive index of a cholesteric liquid crystal and θ denotes an incident angle of light. Similarly, the optical film 200 is used for compensating the color shift phenomenon caused by the wavelength shift of the reflective light in oblique angle incidence. And the optical film also retains the ability for recycling the reflective light back to the backlight module. Therefore, as shown in FIG. 3(b) and (c), the applications of the optical film 200 could be selectively cooperated either with a backlight module 10 or a polarizing film 30.

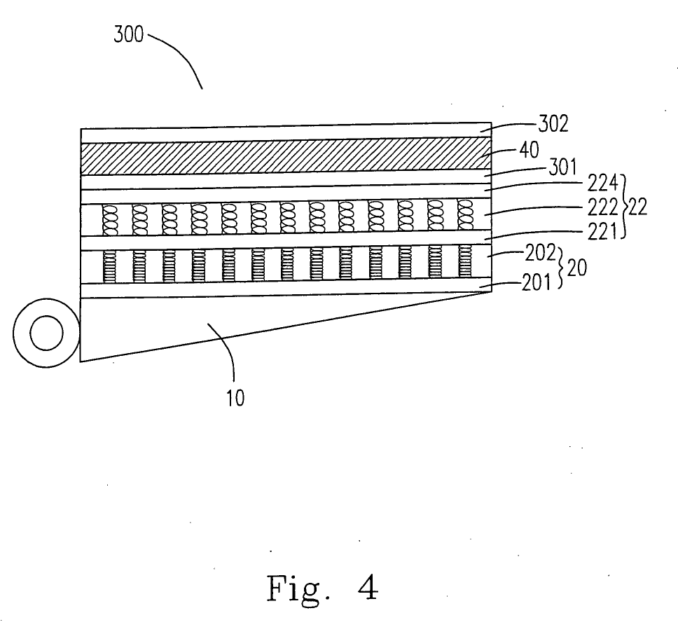

Please refer to FIG. 4, which illustrates the structure of a liquid crystal display according to a preferred embodiment of the present invention. The liquid crystal display 300 includes a backlight module 10, a reflective film 20, a brightness enhancement film 22, a first and a second polarizing films 301, 302 and a liquid crystal layer 40. The backlight module 10 is used for providing a light source for the liquid crystal display 300. The reflective film 20, composed of a first transparent substrate 201 and a first cholesteric liquid crystal 202, is used for reflecting a first reflective light ranged in an infrared spectrum. The brightness enhancement film 22 is composed of a second transparent substrate 221, a second cholesteric liquid crystal 222 and a phase retarder 224. The second cholesteric liquid crystal 222 is used for reflecting a second reflective light which is incapable of transmitting through the second cholesteric liquid crystal 222 and the phase retarder 224 is used for transforming the circular polarized light passing through the second cholesteric liquid crystal 222 into a linear polarized light. The first and the second polarizing films 301 and 302, having polarities perpendicular to each other, are disposed on the brightness enhancement film 22, and the liquid crystal layer 40, sandwiched between the pairs of the polarizing films 301 and 302, is used for directing a light transmitted therebetween.

In this preferred embodiment, both wavelengths of the first and second reflective light are dependent on the structure of the cholesteric liquid crystal, such as the pitch length and the average refractive index, and the incident angle of light. Therefore, the lights reflected by the two cholesteric liquid crystals 202 and 222 satisfy the following formula of λ(θ)=nP₀ cos(sin⁻¹ sin θ/n), wherein λ denotes a wavelength of a reflective light, P₀ denotes a pitch length of a cholesteric liquid crystal, n denotes an average refractive index of a cholesteric liquid crystal and θ denotes an incident angle of light. Accordingly, the wavelength of the first reflective light is controlled within the infrared spectrum range (more than 700nm), and that of the second reflective light is controlled within the visible light spectrum range (with 400 to 700 nm). As a result, when a light from the backlight module 10 propagates into the reflective film 20 with a normal incidence, part of the incident light which is ranged in the infrared spectrum is reflected by the first cholesteric liquid crystal 202, and other part of the incident light which is ranged in the visible light spectrum is reflected by the second cholesteric liquid crystal 222. However, when a light from the backlight module 10 propagates into the reflective film 20 with an oblique incidence, both wavelengths of the first and the second reflective light are shifted into shorter. Accordingly, part of the visible light with red light spectrum (near 700 nm) is capable of passing through the second cholesteric liquid crystal 222. However, with the compensation of the first cholesteric liquid crystal 202, the light with red light spectrum is reflected by the first cholesteric liquid crystal 202 since the wavelength of the infrared (more than 700 nm) is also shifted into the visible light spectrum. As a result, with the combination of the first and the second cholesteric liquid crystal 202 and 222, the wavelengths respectively of the first and the second reflective lights are remained within the range of the visible light spectrum, and the color shift phenomenon caused by the wavelength shift of the reflective light would be eliminated with the compensation of the first cholesteric liquid crystal 202. The light reflected by the first and the second cholesteric liquid crystal 202 and 222, is then re-reflected by the backlight module 10. Because of the polarity of the re-reflected light is changed with the reflection, the re-reflected light is capable of passing through the reflective film 20 and the brightness enhancement film 22. Furthermore, the light, passing through the reflective film 20 and the brightness enhancement film 22, is transformed into a linear polarized light by the phase retarder 224. With the phase retarder 224, the linear polarized light is able to be transmitted into the liquid crystal layer 40 and be directed pixel by pixel with the liquid crystal molecules to from an image for being displayed.

With the assembly of the reflective film 20 and the brightness enhancement film 22, most of the light emitted from the backlight module 10 is able to pass through the first polarizing film 301, and the brightness of the liquid display is hence increased. In addition, the color shift phenomenon is also eliminated with the compensation of the reflective film 20.

Based on the above, a novel optical film for increasing the brightness and for compensating the color shift of the LCD is provided. The provided optical film is able to be assembled either with a polarizing film or a backlight module. Hence, the present invention not only has novelty and progressiveness, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar arrangements.

What is claimed is:

1. A light control film, comprising:
a reflective film for reflecting a first reflective light ranged in an infrared spectrum;
a brightness enhancement film disposed on said reflective film for reflecting a second reflective light which is incapable of transmitting through said brightness enhancement film; and
a polarizing film disposed on said brightness enhancement film for transmitting a light having a specific linear polarity.

2. The light control film according to claim 1, wherein said reflective film comprises a first cholesteric liquid crystal layer.

3. The light control film according to claim 2, wherein said brightness enhancement film comprises a second cholesteric liquid crystal layer and a phase retarder.

4. The light control film according to claim 3, wherein a pitch length of said first cholesteric liquid crystal layer is different from that of said second cholesteric liquid crystal layer.

5. The light control film according to claim 3, wherein both wavelengths of said first and second reflective light, which are reflected respectively by said first and second cholesteric liquid crystal layers, satisfy the following formula: λ(θ)=nP₀ cos(sin⁻¹ sin θ/n), wherein λ denotes a wavelength of a reflective light, P₀ denotes a pitch length of a cholesteric liquid crystal, n denotes an average refractive index of a cholesteric liquid crystal and θ denotes an incident angle of light.

6. The light control film according to claim 3, wherein said phase retarder is a quarter wavelength retarder.

7. The light control film according to claim 1, wherein said polarizing film is an absorptive polarizing film.

8. The light control film according to claim 1, wherein said polarizing film is a linear polarizing film.

9. A light control film, comprising:
a transparent substrate; and
a reflective film, comprising a cholesteric liquid crystal layer, disposed on said transparent substrate for reflecting a reflective light ranged in an infrared spectrum,
wherein said wavelength of said reflective light satisfies the following formula: λ(θ)=nP₀ cos(sin⁻¹ sin θ/n), wherein λ denotes said wavelength of said reflective light, P₀ denotes a pitch length of a cholesteric liquid crystal, n denotes an average refractive index of a cholesteric liquid crystal and θ denotes an incident angle of light.

10. The light control film according to claim 9, wherein said wavelength of said reflective light is more than 700nm.

11. An optical film, comprising:
a reflective film, comprising a first cholesteric liquid crystal layer, for reflecting a first reflective light ranged in an infrared spectrum;
a reflective polarizing film, comprising a second cholesteric liquid crystal layer, disposed on said reflective film for reflecting a second reflective light which is incapable of transmitting through said reflective polarizing film; and
a phase retarder disposed on said reflective polarizing film,
wherein both the wavelengths of said first and second reflective light satisfy the following formula: λ(θ)=nP₀ cos(sin⁻¹ sin θ/n) wherein λ denotes a wavelength of a reflective light, P₀ denotes a pitch length of a cholesteric liquid crystal, n denotes an average refractive index of a cholesteric liquid crystal and θ denotes an incident angle of light.

12. The optical film according to claim 11, wherein a pitch length of said first cholesteric liquid crystal layer is different from that of the second cholesteric liquid crystal layer.

13. The optical film according to claim 11, wherein said phase retarder is a quarter wavelength retarder.

14. A liquid crystal display, comprising:
a backlight module providing a light source for said liquid crystal display;
a reflective film for reflecting a first reflective light ranged in an infrared spectrum;
a reflective polarizing film disposed on said reflective film for reflecting a second reflective light which is incapable of transmitting through said reflective polarizing film;
a phase retarder disposed on said reflective polarizing film;
a first and a second polarizing films, having polarities perpendicular to each other, disposed on said phase retarder; and
a liquid crystal layer sandwiched between said first and second polarizing films for directing a light transmitted therebetween.

15. The liquid crystal display according to claim 14, wherein said reflective film comprises a first cholesteric liquid crystal layer.

16. The liquid crystal display according to claim 15, wherein said reflective polarizing film comprises a second cholesteric liquid crystal layer.

17. The liquid crystal display according to claim 16, wherein a pitch length of said first cholesteric liquid crystal layer is different from that of said second cholesteric liquid crystal layer.

18. The liquid crystal display according to claim 16, wherein both wavelengths of said first and second reflective light which are reflected respectively by said first and second cholesteric liquid crystal layers satisfy the following formula: λ(θ)=nP₀ cos(sin⁻¹ sin θ/n), wherein λ denotes a wavelength of a reflective light, P₀ denotes a pitch length of a cholesteric liquid crystal, n denotes an average refractive index of a cholesteric liquid crystal and θ denotes an incident angle of light.

19. The liquid crystal display according to claim 14, wherein said first and second polarizing films are absorptive polarizing films.

20. The liquid crystal display according to claim 14, wherein said phase retarder is a quarter wavelength retarder.
